(19) United States
(12) Patent Application Publication
(10) Pub. No.: US 2026/0235911 A1
(43) Pub. Date: Aug. 13, 2026

(54) DISPLAY SYSTEMS COMPRISING SPACERS DISPOSED BETWEEN FRAME AND DISPLAY BACK PANEL AND ASSOCIATED METHODS

(71) Applicant: CORNING INCORPORATED, CORNING, NY (US)

(72) Inventors: Peter Steven Cole, Corning, NY (US); Nathanael Craige, Campbell, NY (US); Jean-Luc Dabouineau, Nemours (FR); Achim Karl-Erich Heibel, Corning, NY (US); Khaled Layouni, Fontainebleau (FR); Joseph Taylor Parshall, Sayre, PA (US); Jason Scott Stewart, Hornell, NY (US); Arlin Lee Weikel, Mansfield, PA (US)

(21) Appl. No.: 19/151,036

(22) PCT Filed: Jan. 22, 2024
(86) PCT No.: PCT/US2024/012352

§ 371 Date: Jul. 25, 2025

Related U.S. Application Data
(60) Provisional application No. 63/443,079, filed on Feb. 3, 2023.
(60) Provisional application No. 63/523,699, filed on Jun. 28, 2023.

(51) Int. Cl. G02F 1/1339; G02F 1/1333

(52) U.S. Cl. CPC G02F 1/13398; G02F 1/133302; G02F 1/133314

(57) ABSTRACT

A display system comprises a glass substrate, a frame comprising a curved support surface, an adhesive layer compring an adhesive that is disposed between the curved support surface and the glass substrate, and a display module comprising a back panel. The adhesive layer retains the glass substrate in the shape of the curved support surface. There is a gap between a peripheral edge of the back panel and an inner edge of the frame. A spacer disposed in the gap and extends an entirety of a distance between the peripheral edge and the inner edge to maintain the gap during fabrication of the display system and facilitate the adhesive layer having a uniform thickness. Spacers for containing the adhesive during fabrication, methods of shaping the adhesive layer, frame features for containing flows of the adheisve, ways of shaping the adhesive layer, and fabrication methods are also described.

### CROSS-REFERENCE TO RELATED APPLICATIONS

This application claims the benefit of priority under 35 U.S.C. § 119 of U.S. Provisional Application Serial No. 63/443079 filed on Feb. 3, 2023, and U.S. Provisional Application Serial No. 63/523699 filed on Jun. 28, 2023, the contents of which are relied upon and incorporated herein by reference in their entirety.

### BACKGROUND

The present disclosure relates to glass articles for display systems including cold-formed glass substrates that are structured to address various issues that may arise from shape mismatches between various components of the system. In particular embodiments, the present disclosure relates to display systems comprising a spacer disposed in a gap between a display module and a frame upon which the glass substrate is cold-formed.

Vehicle interiors may incorporate glass surfaces as part of the aesthetic and functional design of the vehicle. Such glass surfaces may be bonded to a frame system that attaches the glass surface to the vehicle interior. The frames may be constructed of a suitable material (e.g., aluminum, magnesium) that is more rigid than the glass to facilitate the frame maintaining the glass in a bent shape that deviates from an equilibrium shape of the glass in isolation. Fabrication methods of frames formed of such materials may not be perfectly consistent from part-to-part, leading to some shape variability from frame-to-frame. Such shape variability can create difficulties in fabricating systems incorporating bent glass.

Accordingly, constructions of display systems and fabrication methods that alleviate the effects of frame shape variability are desired.

### SUMMARY

According to an embodiment of the present disclosure, a display system comprises: a glass substrate comprising a first major surface and a second major surface; a frame comprising a curved support surface, the frame comprising an inner edge defining an opening; an adhesive layer disposed between the curved support surface and the second major surface and attaching the glass substrate to the frame to conform the glass substrate to the curved support surface, wherein the second major surface comprises an open region that is not adhered to the frame and overlaps the opening; a display module disposed in the opening and adhered to the open region, wherein the display module comprises a display layer and a back panel, wherein there is a gap disposed between a peripheral edge of the back panel and the inner edge, wherein the frame is not bolted to the back panel; and a spacer disposed in the gap and extending an entirety of a distance between the peripheral edge and the inner edge.

According to another embodiment of the present disclosure, a method of forming a display system comprises: cold-forming a glass substrate against a curved support surface of a frame with an adhesive layer disposed between the curved support surface and the glass substrate, wherein the frame comprises an opening; laminating a display module to the glass substrate within the opening via a layer of optically clear adhesive, wherein the display module comprises a back panel and wherein a peripheral edge of the back panel is separated from an interior edge of the frame by a gap; disposing a spacer in the gap, wherein the spacer bonds the back panel to the frame and maintains a shape of the gap; and curing the adhesive layer such that the glass substrate is retained in a curved shape by the frame.

According to another embodiment of the present disclosure, a display system comprises: a glass substrate comprising a first major surface and a second major surface; a frame comprising a curved support surface, the frame defining an opening; an adhesive layer disposed between the curved support surface and the second major surface and attaching the glass substrate to the frame to conform the glass substrate to the curved support surface, wherein the second major surface comprises an open region that is not adhered to the frame and overlaps the opening; a display module disposed in the opening and adhered to the open region, wherein the display module comprises a display layer and a back panel, wherein there is a gap disposed between a peripheral edge of the back panel and an inner edge of the frame, wherein the frame is not bolted to the back panel; a spacer disposed in the gap and extending an entirety of a distance between the peripheral edge and the inner edge; and at least one of: a spacing element disposed between the curved support surface and the second major surface proximate to a periphery of the second major surface, a step or through-hole on the curved support surface, and a trough extending from the inner edge of the frame.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a vehicle interior having curved glass surfaces, according to an exemplary embodiment;

FIGS. 2A and 2B depict side views of embodiments of curved glass articles that may be used in the vehicle interior of FIG. 1, according to exemplary embodiments;

FIG. 3 schematically depicts a glass substrate being cold-formed to a frame via a vacuum chuck, according to an exemplary embodiment;

FIG. 4A schematically depicts a rear view of a display system, according to one or more embodiments of the present disclosure;

FIG. 4B schematically depicts a cross-sectional view of the display system through the line 4B-4B in FIG. 4A, according to one or more embodiments of the present disclosure;

FIG. 4C schematically depicts the display system depicted in FIGS. 4A-4B during fabrication thereof where a spacer precursor material is injected into a gap between a back panel and a frame, according to one or more embodiments of the present disclosure;

FIG. 4D schematically depicts the display system depicted in FIGS. 4A-4B during fabrication thereof where a spacer is attached to a back panel prior to a display module being laminated to a glass substrate of the display system, according to one or more embodiments of the present disclosure;

FIG. 5 schematically depicts a display system comprising a spacing element disposed between a glass substrate and a frame thereof, according to one or more embodiments of the present disclosure;

FIG. 6 schematically depicts a display system comprising a step at an inner edge of a curved support surface of a frame and a trough extending from the inner edge, according to one or more embodiments of the present disclosure;

FIG. 7A schematically depicts a display system positioned on a vacuum chuck with a removable adhesive shaping element positioned in contact with a minor surface of a glass substrate, according to one or more embodiments of the present disclosure;

FIG. 7B schematically depicts a display system positioned on a vacuum chuck with an adhesive shaping element forming a part of forming surface of the vacuum chuck and also contacting a minor surface of a glass substrate, according to one or more embodiments of the present disclosure;

FIG. 8 is a flow diagram of a process of fabricating a display system, according to one or more embodiments of the present disclosure;

FIG. 9A schematically depicts a cross-sectional view of a region of the display system depicted in FIG. 5, according to an example embodiment, according to one or more embodiments of the present disclosure; and

FIG. 9B schematically depicts the portion depicted in FIG. 9A during fabrication prior an adhesive layer 66 being compressed, according to one or more embodiments of the present disclosure.

### DETAILED DESCRIPTION

Reference will now be made in detail to various embodiments, examples of which are illustrated in the accompanying drawings. The present disclosure generally relates to displays comprising a cold-formed glass substrate that is adhered to a curved support surface of a frame via an adhesive layer. The curved support surface of the frame defines a bonding area on which the adhesive layer may be disposed. However, the size and shape of the bonding area may not be precisely known during the fabrication of the display and, as a result, a spacing between the curved support surface and the glass substrate may vary and/or a quantity of adhesive dispensed at each location within the bonding area may not be adequate. For example, certain areas of the curved support surface may deviate from a desired shape and, as a result, a depth of a space between the glass substrate and curved support surface may be smaller than in other areas. Such reduced-depth areas may result in adhesive being forced outward from the bonding area (e.g., oozing outward of the frame) and/or the adhesive layer having a non-uniform thickness, resulting in a wavy appearance of the adhesive layer. Aspects of the present disclosure aim to alleviate the effects associated with frame shape variations. By eliminating or reducing negative effects of frame-to-frame variability, the present disclosure enables frame constructions with less stringent manufacturing tolerances, thereby saving costs and streamlining the manufacturing process for curved displays.

According to aspects of the present disclosure, the display may include a display module comprising a rigid back panel. The rigid back panel may have a desired shape (e.g., have a curvature that substantially matches the curved support surface of the frame). However, mechanical interactions between the frame and the rigid back panel may cause the back panel to deviate from this desired shape and/or cause the frame to unpredictably bend away from an expected configuration, thereby causing the precise spacing between the frame and the glass to be non-uniform. In accordance with the present disclosure, to prevent such frame-to-back panel variations from unpredictably effecting the shape of the glass or adhesive, the back panel is not bolted to the frame, as it is in certain existing designs. Instead, a spacer is inserted between the back panel and the frame and the spacer is configured to fix the shape of a gap between the back panel and frame prior to there being any mechanical interactions between the back panel and frame. For example, the spacer can be a compliant material (e.g., a suitable adhesive or elastomeric material) that can accommodate geometrical mismatches between the frame and back panel. As a result of the spacer, unpredictable bending of the frame and back panel due to unknown geometrical variations is suppressed and variations in adhesive thickness are more controlled (by controlling the dimensions of space between the frame and the glass substrate during the fabrication process). In another example, the spacer can be rigid material but have a shape that conforms to the shape of the gap between the back panel and frame so the shape of the gap is maintained throughout the fabrication process. The spacer facilitates greater control of the shape of the overall structure of the glass substrate, frame, and display module resulting from the manufacturing process.

In addition to the spacer between the back panel and frame described herein, various other aspects of the frame and fabrication process can be tailored to control adhesive thickness and/or overflow. For example, in embodiments, a spacing element is disposed around a periphery of the bonding area prior to the adhesive layer being deposited. The spacing element can determine the thickness of the adhesive layer and prevent the adhesive from overflowing during the fabrication process. Alternatively or additionally, feedback can be added to the adhesive dispensing process such that the volume of the adhesive dispensed on a particular location of the bonding area is varied depending on at least one of the size of the frame at that location (e.g., a bezel width) and the curvature of the curved support surface (e.g., areas where the curved support surface is curved away from a desired shape may have more or less adhesive dispensed than areas where the curved support surface has a desired shape). Additionally or alternatively, at least an outer surface of the adhesive may be textured during or after the dispensing thereof to render the adhesive less glossy and visible. Additionally or alternatively, the curved support surface of the frame can include one or more steps or openings disposed inward of a peripheral edge of the frame. The steps or openings can create space between the glass and curved support surface for the adhesive to flow into, preventing overflow. Additionally or alternatively, an exterior dam can be placed around the periphery of the glass substrate and frame to prevent overflow of the adhesive during cold-forming. The exterior dam can be removably disposed at the periphery of the glass to control both the thickness of the adhesive and prevent adhesive overflow. In embodiments, the spacer can be a component of a vacuum chuck used during the fabrication process and be a support for the glass substrate on the vacuum chuck. Any of these concepts may be used individually or in combination with any of the other concepts described herein to aid in providing a uniform adhesive layer despite an unpredictable frame shape.

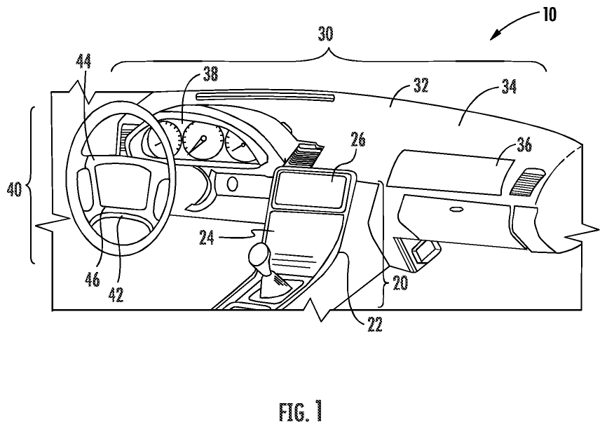

FIG. 1 shows an exemplary interior 10 of a vehicle that includes three different embodiments of vehicle interior systems 20, 30, 40. Vehicle interior system 20 includes a base, shown as center console base 22, with a curved surface 24 including a display 26. Vehicle interior system 30 includes a base, shown as dashboard base 32, with a curved surface 34 including a display 36. The dashboard base 32 typically includes an instrument panel 38 which may also include a display. Vehicle interior system 40 includes a base, shown as steering wheel base 42, with a curved surface 44 and a display 46. In one or more embodiments, the vehicle interior system includes a base that is an arm rest, a pillar, a seat back, a floorboard, a headrest, a door panel, or any portion of the interior of a vehicle that includes a curved surface. In other embodiments, the base is a portion of a housing for a free-standing display (i.e., a display that is not permanently connected to a portion of the vehicle). While the displays 26 and 36, and instrument panel 38 are depicted as being separate from one another in FIG. 1, it should be understood that embodiments are contemplated where at least two the displays 26 and 36 and the instrument panel 38 are combined with one another. For example, in embodiments, a single glass substrate extends an entirety of the length of the dashboard base 32 between pillars (not depicted) of the interior 10. As described herein, such a glass substrate may be curved to a desired shape and have one or more displays attached thereto via the methods described herein. In an example, a pillar-to-pillar display can be implemented, where a single display extends a substantial portion of the length of the glass substrate.

The embodiments of the curved glass articles described herein can be used in each of vehicle interior systems 20, 30, 40, among others. In some such embodiments, the glass article discussed herein may include a cover glass sheet that also covers non-display surfaces of the dashboard, center console, steering wheel, door panel, etc. In such embodiments, the glass material may be selected based on its weight, aesthetic appearance, etc. and may be provided with a coating (e.g., an ink or pigment coating) with a pattern (e.g., a brushed metal appearance, a wood grain appearance, a leather appearance, a colored appearance, etc.) to visually match the glass components with adjacent non-glass components. In specific embodiments, such ink or pigment coating may have a transparency level that provides for deadfront or color matching functionality when the display 26, 36, 46 is inactive. Further, while the vehicle interior of FIG. 1 depicts a vehicle in the form of an automobile (e.g., cars, trucks, buses and the like), the glass articles disclosed herein can be incorporated into other vehicles, such as trains, sea craft (boats, ships, submarines, and the like), and aircraft (e.g., drones, airplanes, jets, helicopters and the like).

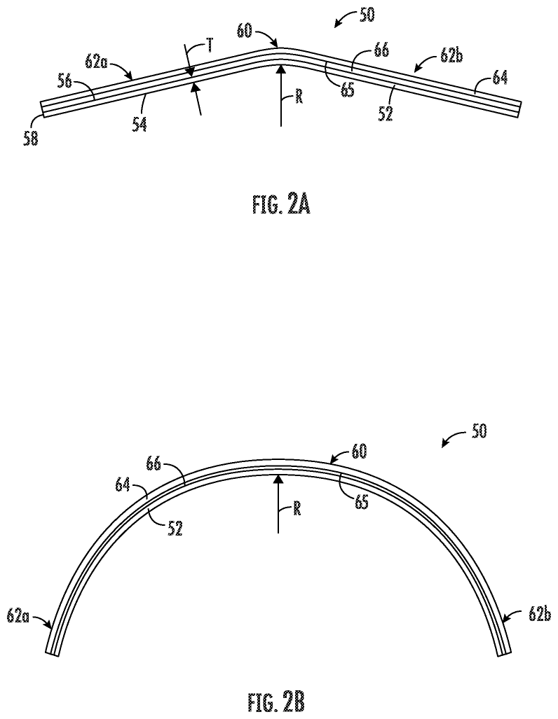

In embodiments, the curved surfaces 24, 34, 44 can be any of a variety of curved shaped, such as V-shaped or C-shaped as shown in FIGS. 2A and 2B, respectively. Referring first to FIG. 2A, a side view of an embodiment of a V-shaped glass article 50 is shown. The glass article 50 includes a glass substrate 52 having a first major surface 54, a second major surface 56 opposite to the first major surface 54, and a minor surface 58 joining the first major surface 54 to the second major surface 56. The first major surface 54 and the second major surface 56 define a thickness T of the glass substrate 52. In embodiments, the thickness T of the glass substrate 52 is from 0.3 mm to 2 mm, in particular 0.5 mm to 1.1 mm. In a vehicle, the first major surface 54 faces the occupants of the vehicle.

In embodiments, the first major surface 54 and/or the second major surface 56 includes one or more surface treatments. Examples of surface treatments that may be applied to one or both of the first major surface 54 and second major surface 56 include an anti-glare coating, an anti-reflective coating, a coating providing touch functionality, a decorative (e.g., ink or pigment) coating, and an easy-to-clean coating.

As can be seen in FIG. 2A, the glass substrate 52 has a curved region 60 disposed between a first flat section 62a and a second flat section 62b. In embodiments, the curved region 60 has a radius of curvature R that is from 75 mm to a radius of curvature that is less than substantially flat or planar (e.g., R=10 m). In particular, the curved region 60 has a radius of curvature R that is from 150 mm to 3000 mm. Further, as shown in FIG. 2A, the curved region 60 defines a concave curve with respect to the first major surface 54, but in other embodiments, the curved region 60 is instead a convex curve with respect to the first major surface 54.

In the glass article 50 of FIG. 2A, a frame 64, particularly a curved support surface 65 thereof, is adhered to the second major surface 56 of the glass substrate 52 using an adhesive layer 66. The adhesive layer 66 may initially be deposited on the glass substrate 52 or frame 64 as a liquid adhesive bead and subsequently cured. In embodiments, exemplary adhesives for the adhesive layer 66 include epoxies, acrylics, polyurethanes, polyurethane hotmelts, silane modified polymers and/or silicones. In specific embodiments, the adhesive layer 66 includes one or more toughened epoxies, such as EP21TDCHT-LO (available from MasterBond®, Hackensack, NJ), 3M™ Scotch-Weld™ Epoxy DP460 Off-White (available from 3M, St. Paul, MN). In other embodiments, the adhesive layer 66 includes one or more flexible epoxies, such as MasterBond EP21TDC-2LO (available from MasterBond®, Hackensack, NJ), 3M™ Scotch-Weld™ Epoxy 2216 B/A Gray (available from 3M, St. Paul, MN), and 3M™ Scotch-Weld™ Epoxy DP125.

In still other embodiments, the adhesive layer 66 includes one or more acrylics, such as LORD® Adhesive 410/Accelerator 19 w/LORD® AP 134 primer, LORD® Adhesive 852/LORD® Accelerator 25GB (both being available from LORD Corporation, Cary, NC), DELO PUR SJ9356 (available from DELO Industrial Adhesives, Windach, Germany), Loctite® AA4800, Loctite® HF8000. In still others, the liquid adhesive includes silane modified polymers, such as TEROSON® MS 9399, and TEROSON® MS 647-2C (these latter four being available from Henkel AG & Co. KGaA, Düsseldorf, Germany), or one or more silicones, such as Dow Corning® 995, Dow Corning® 7091 (available from Dow Corning Corporation, Midland, MI), among others.

In yet other embodiments, the adhesive layer 66 includes one or more polyurethane hotmelts, such as Loctite HHD 3542 (available from Henkel AG & Co. KGaA, Düsseldorf, Germany). In yet other embodiments, the adhesive layer 66 includes one or more polyurethanes, such as 3M™ Scotch-Weld™ Urethane DP640 Brown, 3M™ Scotch-Weld™ Urethane DP604 (both available from 3M, St. Paul, MN), Betamate™ 73100, Betaseal™ X2500 and Betalink™ K2 (these latter three being available from The Dow Chemical Company, Midland, MI).

In embodiments, the material of the adhesive layer 66 comprises an elastic modulus of from 0.1 MPa to 50 MPa. Further, in embodiments, the material of the adhesive layer 66 comprises a viscosity of 1 kcps to 500 kcps when deposited. In part, the frame 64 facilitates mounting the glass article 50 to a vehicle interior base (such as center console base 22, dashboard base 32, and/or steering wheel base 42 as shown in FIG. 1). Additionally, via the shape of the curved support surface 65 and bonding with the adhesive layer 66, the frame 64 retains the glass substrate in a bent state such that the curved region 60 is not permanent. That is, the glass substrate 52 would spring back to a planar, non-curved configuration if the glass substrate 52 was not adhered to the frame 64 using the adhesive layer 66. Thus, the glass substrate 52 is stressed to produce the curvature and remains stressed during the life of the glass article 50. The curved support surface 65 can have various sizes and shapes depending on the implementation. In embodiments, for example, curved support surface 65 comprises a peripheral shape that substantially matches that of the glass substrate 52 (once the glass substrate 52 is bent in a stressed configuration). In such embodiments, the curved support surface can comprise a length that is greater than or equal to 500 mm and less than or equal to 3000 mm, a width that is less than half of the length; and a minimum radius of curvature that is greater than or equal to 100 mm and less than or equal to 1500 mm.

The stress in the glass substrate 52 tends to cause the glass substrate 52 to pull away from the frame 64, which means that the adhesive layer 66 is also stressed. This stress can be further exacerbated by stresses caused by thermal cycling. In particular, the glass substrate 52 has a different coefficient of thermal expansion than that of the frame 64, which is typically a metal (e.g., aluminum or magnesium), composite, or plastic component. The difference in coefficients of thermal expansion mean that the glass substrate 52 and frame expand or contract different amounts during thermal cycling between temperature extremes (e.g., as low as −40° C. and as high as 80° C.), causing additional stress in the adhesive layer 66. While the mechanical and thermal stresses can be accounted for by expanding the adhesive layer 66 (in terms of thickness and or surface area), aesthetic considerations constrain the size of the adhesive layer 66. In particular, it is desired to minimize the area of the adhesive layer 66 in contact with the glass substrate 52 in order to maximize a display area of the glass article 50.

FIG. 2B depicts another embodiment of a glass article 50, in particular a C-shaped glass article 50. As compared to the V-shaped glass article 50 of FIG. 2A, the C-shaped glass article 50 of FIG. 2B has a larger curved region 60 and shorter flat sections 62a, 62b. The V-shape and C-shape are but two examples of curved glass articles 50 that can be created according to the present disclosure. In other embodiments, the glass articles 50 can include curved regions 60 having opposing curvatures to create an S-shape, a curved region 60 followed by a flat section 62a to create a J-shape, and curved regions 60 separated by a flat section 62a to create a U-shape, among others. Embodiments are also envisioned where the curved region 60 is cylindrical shaped having a constant minimum radius of curvature. Embodiments are also envisioned where at least a portion of the curved region 60 comprises a complex curvature (where the major surfaces 54 and 56 are curved along at least two axes of curvature extending in different directions from one another).

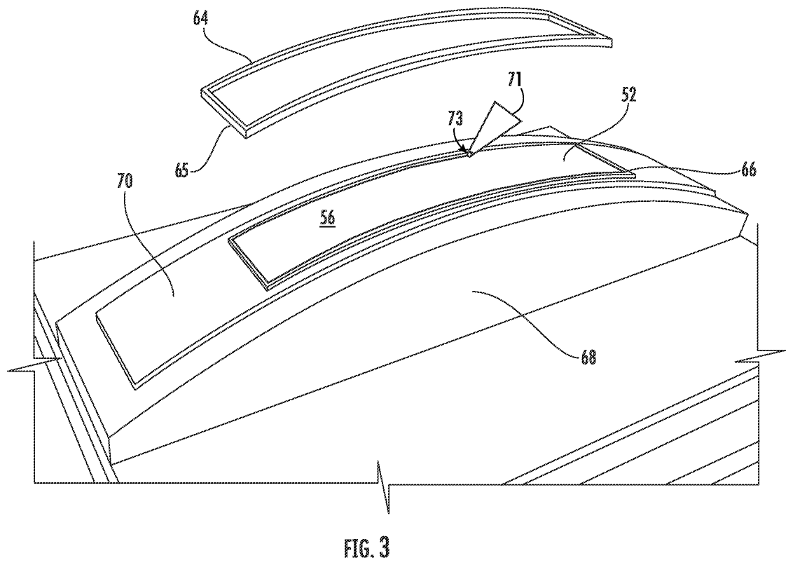

The glass articles 50 according to the present disclosure are formed by cold-forming techniques. An example process of cold-forming involves application of a bending force to the glass substrate 52 while the glass substrate 52 is situated on a chuck 68 as shown in FIG. 3. As can be seen, the chuck 68 has a curved forming surface 70, and the glass substrate 52 is bent into conformity with the curved forming surface 70. Advantageously, it is easier to apply surface treatments to a flat glass substrate 52 prior to creating the curvature in the glass substrate 52, and cold-forming allows the treated glass substrate 52 to be bent without destroying the surface treatment (as compared to the tendency of high temperatures associated with hot-forming techniques to destroy surface treatments, which requires surface treatments to be applied to the curved article in a more complicated process). In embodiments, the cold forming process is performed at a temperature less than the glass transition temperature of the glass substrate 52. In particular, the cold forming process may be performed at room temperature (e.g., about 20 ° C.) or a slightly elevated temperature, e.g., at 200° C. or less, 150° C. or less, 100° C. or less, or at 50° C. or less.

In embodiments, the bending force applied to the glass substrate 52 may be in the form of vacuum pressure pulled through the chuck 68. In embodiments, the chuck 68 includes interior channels having ports on the forming surface 70 of the chuck 68. When the glass substrate 52 is situated on the forming surface 70, vacuum is pulled through the channels to hold the glass substrate 52 against the chuck and into conformity with the curvature of the forming surface 70. In other embodiments, the forming surface 70 may hold the glass substrate 52 into compliance with the curvature using other techniques. For example, the forming surface 70 may be a self-adhesive material configured to provide sufficient adhesion to hold the glass substrate 52 in the curved configuration during cold forming, or the chuck 68 may operate in conjunction with a press or clamps that hold the glass substrate 52 into conformity with the forming surface 70 during cold-forming. In embodiments, cold-forming the glass substrate 52 may not use the vacuum chuck 68. For example, the glass substrate 52 may be bent to the frame 64 and secured thereto by clamps or other suitable fixation means while the adhesive layer 66 cures.

In the embodiment shown in FIG. 3, the adhesive layer 66 is applied to the second major surface 56 of the glass substrate 52, and the frame 64 is lowered onto the glass substrate 52. However, in other embodiments, the adhesive layer 66 could instead be applied to the curved support surface 65 of the frame 64. In either case, the frame 64 will compress the adhesive layer 66 between the curved support surface 65 and the second major surface 56 of the glass substrate 52. As can be seen in FIG. 3, the adhesive layer 66 is being applied to the glass substrate 52 in such a manner that the shape traced by the adhesive layer 66, i.e., the “bead path,” substantially matches the shape of the frame 64. In embodiments, the adhesive layer 66 defines a closed bead path such that the adhesive layer 66 is continuous on the glass substrate 52. In other embodiments, the adhesive layer 66 may have a discontinuous bead path, e.g., have breaks between sections of adhesive layer 66. FIG. 3 depicts the material of the adhesive layer 66 in an uncured, as applied condition in the form of an adhesive bead.

In embodiments, the adhesive layer 66 is applied via a nozzle 71 having a circular port 73 as shown in FIG. 3. Advantageously, such nozzles allow for ease of manufacturing because the orientation of the nozzle relative to the glass substrate 52 is not limited in comparison to certain nozzles having, e.g., triangular shaped ports, which much be aligned in a specific orientation with respect to a glass sheet in order to apply a shaped adhesive bead in the proper position. Further, while FIG. 3 depicts the adhesive layer 66 being applied to the glass substrate 52 when the glass substrate 52 is in a curved configuration over the chuck 68, the adhesive layer 66 could instead be applied to the glass substrate 52 when the glass substrate 52 is in a flat configuration such that the glass substrate 52 having the adhesive layer 66 applied thereto is subsequently bent over the forming surface 70 of the chuck 68. In embodiments, the nozzle 71 is connected to a movement system and controller (not depicted). The controller may include an imaging device that determines a shape of the curved support surface 65 via image analysis techniques. The shape of the curved support surface 65 may be compared to an idealized surface (representing a designed curved shape for the curved support surface 65). Deviations between the actual and idealized shape can be used to control the rate and/or volume of adhesive dispensed at a particular location on the glass substrate 52 or frame 64. Areas where the actual shape of the curved support surface 65 is further away from the second major surface 56 than the idealized surface can be provided with a greater volume of adhesive (by slowing movement of the nozzle 71 down or by increasing the deposition rate) and areas where the actual shape of the curved support surface 65 is closer to the second major surface 56 than the idealized shape may be provided with a smaller volume of adhesive (by speeding movement of the nozzle 71 up or by decreasing the deposition rate). Such adhesive deposition control can reduce an amount of adhesive overflow.

Irrespective of the particular process steps employed, cold-forming the glass substrate generally involves the application of a force to the glass substrate 52 to bend the glass substrate 52 in a shape that substantially conforms to the frame 64. For example, in embodiments, the forming surface 70 of the chuck 68 has a shape that substantially corresponds to a shape of the curved support surface 65 of the frame 64 such that applying a vacuum to the glass substrate 52 to conform the glass substrate 52 to the forming surface 70 causes the second major surface 56 to bend into a shape of the curved support surface 35. Alternatively or additionally, a pre-form, roller, or other force application device can be used to force the glass substrate 52 directly against the curved support surface 65 to cause the second major surface 56 to bend into conformity thereto.

Issues can arise when the frame 64 deviates from a desired shape. For example, when constructed of a metal such as aluminum or magnesium, the frame 64 can be fabricated with a casting process that has some variability. In the depicted example, the curved support surface 65 may not precisely match the shape of the forming surface 70 of the chuck 68. As a result, the spacing between the curved support surface 65 and the second major surface 56 may be non-uniform even when the positioning of the frame 64 is precisely controlled during the fabrication process. Additionally, the dimensions of the frame 64 can vary, changing the dimensions of the curved support surface 65 from expected values at various locations, leading to changes in available bonding area on which the adhesive layer 66 can be disposed between the glass substrate 52 and frame 64. Such inconsistencies in the shape of the frame 64 may lead to issues in dispensing the adhesive layer 66. To illustrate, if the adhesive layer 66 is dispensed to have a uniform volume over the entirety of the bead path, regions where the bonding area and/or space between the curved support surface 65 and second major surface 56 are smaller than expected may result in the adhesive overflowing (e.g., either outwards from the periphery of the frame 64 or inwards towards a center of the glass substrate 52). Variations in curvature of the curved support surface 65 may cause the thickness of the adhesive layer 66 to vary, as the adhesive layer 66 may be compressed by the curved support surface 65 prior to the adhesive layer 66 curing. Such thickness variations may give the adhesive layer 66 a wavy appearance, which is undesirable.

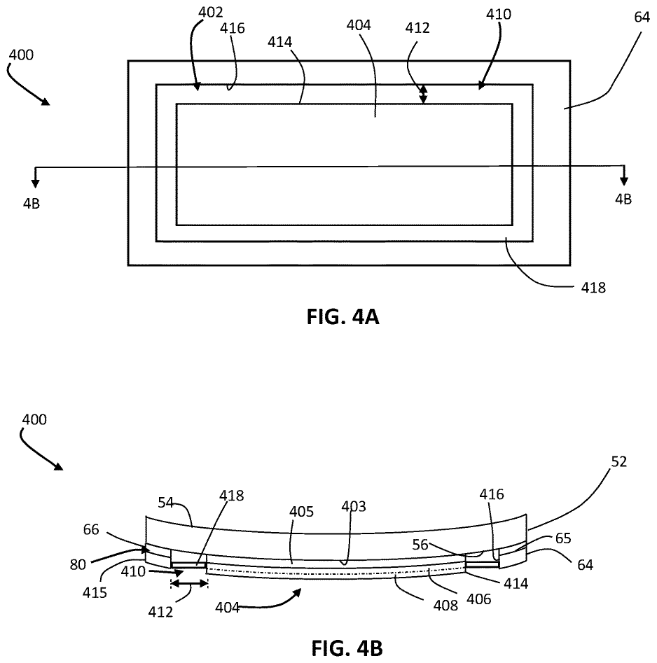

Such problems associated with frame shape variability may be even further exacerbated when a display module is incorporated into the curved glass article to form a display system. FIGS. 4A and 4B schematically depict a display system 400, according to an example embodiment of the present disclosure. FIG. 4A schematically depicts a rear-facing view of the display system 400 (e.g., from the side of the second major surface 56) and FIG. 4B schematically depicts a cross-sectional view through the line 4B-4B in FIG. 4A. As shown, in the depicted embodiment, the curved support surface 65 of the frame 64 is curved to have a concave shape and the glass substrate 52 is cold-formed and adhered to the curved support surface 65 via the adhesive layer 66 such that the first major surface 54 also has a concave shape. The glass substrate 52 is cold-formed to the curved support surface 65 via any suitable technique. For example, in embodiments, the vacuum chuck 68 and nozzle 71 depicted in FIG. 3 may be used to bend the glass substrate 52 and dispense the adhesive layer 66.

As shown in FIG. 4B, an area of overlap between the curved support surface 65 and the second major surface 56 defines a bonding area 80 on which the adhesive layer 66 can be disposed to attach the glass substrate 52 to the frame 64. In embodiments, the frame 64 is constructed to have a peripheral shape that substantially matches that of the glass substrate 52 after the glass substrate is bent. In such embodiments, or other embodiments where the periphery of the frame 64 is inset from the minor surface 58 (see FIG. 2A), the bonding area 80 extends from a peripheral edge 415 of the frame to an inner edge 416 of the frame 64. That is, the shapes of the peripheral edge 415 and the inner edge 416 determine the extent of the bonding area 80. Moreover, the shape of the curved support surface 65, in conjunction with the bonding area 80, can determine the volume of a space between the curved support surface 65 and the second major surface 56 when the frame 64 is held in fixed relation to the glass substrate 52. The shape and size of the frame 64 therefore determines an amount of adhesive that can be applied between the glass substrate 52 and frame 64 at a particular location.

With reference to FIGS. 4A and 4B, the inner edge 416 of the frame 64 may define an opening 402. As a result of the opening 402, the second major surface 506 includes an open region 403 that is not adhered to the frame 64 via the adhesive layer 66. A display module 404 is disposed within the opening 402 and adhered to the second major surface 56 via a layer of optically clear adhesive 405. The display module 404 can be attached to the glass substrate 52 during the cold-forming process (e.g., while the glass substrate 52 is disposed on the chuck 68 and prior to the adhesive layer 66 being cured or prior to the frame 64 being attached to the glass substrate 52) via a suitable lamination technique.

The display module 404 can include a display layer 406 and a back panel 408. The display layer 406 can include a touch panel and other display components (e.g., liquid crystal display panel, organic light emitting diode display panel). The back panel 408 may generally be more rigid than the display layer 406 and be pre-curved to have a desired shape. For example, in embodiments where the display module 404 is a liquid crystal display, the back panel 408 can be a backlight unit and include a light source and a light guide layer. In embodiments where the display module 404 is an organic light emitting diode display, the back panel 408 can be a built in heatsink. The different components of the display module 404 can be attached to the glass substrate 52 in a variety of ways. For example, in embodiments, the display module 404 is a pre-assembled unit (e.g., as a curved display) and laminated to the glass substrate in single processing step. In embodiments, the display layer 406 and back panel 408 are successively attached to the glass substrate 52 in different steps of the cold-forming process. For example, the display layer 406 can be attached to the glass substrate 52 in a first step (when the glass is flat or bent) and the back panel 408 can be attached to the glass substate 52 in a second step after attachment of the display layer 406.

In embodiments, the back panel 408 is more rigid than the glass substrate 52 and curved to have a shape that matches a desired shape of the open region 403. For example, the back panel 408 may be curved to have a shape that substantially corresponds to the frame 64. However, the variability in the shape of the frame 64 described herein can make achieving perfect conformity difficult. As a result, the curvature of the frame 64 may deviate from that of the back panel 408 and/or the opening 402 may not be exactly an expected size. Such discrepancies can create difficulties in attaching the back panel 408 to the frame 64. In certain existing display systems, the back panel 408 and frame 64 are secured to one another by rigid fasteners (e.g., bolts) that utilize pressure to secure the frame 64 and back panel 408 to one another and stabilize the system. Such fastener-based attachment mechanisms can induce a hyperstatic system and cause the less rigid component of the frame 64 and the back panel 408 to bend. Because the precise shape of the frame 64 may not be known, the frame 64 or back panel 408 may bend in unpredictable ways, causing the spacing between the second major surface 56 and the curved support surface 65 to vary, thereby altering the thickness profile of the adhesive layer 66.

In view of the foregoing issues caused by the variability in the shape of the frame 64, the frame 64 is not secured to the back panel 408 through rigid fasteners like bolts. Instead, a spacer 418 is disposed in a gap 410 extending between a peripheral edge 414 of the back panel 408 and the inner edge 416 of the frame 64. The size and shape of the gap 410 is generally determined by the size and shape of each of the frame 64 and the back panel 408. In embodiments, the opening 402 is greater in size than the back panel 408; and the gap 410 surrounds an entirety of the peripheral edge 414. In alternative embodiments, the gap 410 does not completely surround the back panel 408 (e.g., the gap 410 may only extend on one side of the back panel 408). The gap 410 is shown to have a width 412 extending perpendicular to the inner edge 416 of the frame 64. In embodiments, the width 412 is less than or equal to 2 mm (e.g., greater than or equal to 0.01 mm and less than or equal to 2.0 mm, greater than or equal to 0.2 mm and less than or equal to 2.0 mm). In embodiments, the back panel 408 is disposed in the opening 402 (e.g., centered) such that the width 412 is circumferentially uniform (varying from an average value by less than 5% as a function of azimuthal position). Minimizing the size of the gap 410 beneficially maximizes the portion of the opening 402 filled by the display module 404.

The spacer 418 is configured to maintain the relative positioning of the frame 64 and back panel 408 throughout the fabrication process to prevent deformation of the frame 64 and/or back panel 408. To illustrate, FIG. 4C depicts an example where the display system 400 is being fabricated. As shown, the glass substrate 52 is disposed on the forming surface 70 of the chuck 68. The chuck 68 may be applying a negative pressure to the glass substrate 52 to bend the glass substrate 52. Further, the frame 64 has been aligned with the glass substrate 52 with the adhesive layer 66 disposed between the frame 64 and the glass substrate 52. The frame 64 is disposed a distance from the glass substrate 52 based on a desired thickness of the adhesive layer 66 after curing (the frame 64 may be held in such a position by a suitable holding device, not depicted). When the adhesive layer 66 is not yet fully cured, the display module 404 is laminated to the glass substrate 52 via the layer of optically clear adhesive 405 so as to form the gap 410 between the frame 64 and the back panel 408. In embodiments, the periphery of the frame 64 is aligned with the minor surface 58 (see FIG. 2A) to maximize the size of the opening 402 and display area. In embodiments, the periphery of the frame 64 is disposed inward of the minor surface 58. Such a structure may aid in concealing variations in the adhesive layer 66.

The exact geometric shape and dimensions of the gap 410 will vary depending on the geometry of the frame 64. That is, the exact geometry of the gap 410 will vary from part-to-part as the construction of the frame 64 may vary for the reasons described herein. Accordingly, the spacer 418 (see FIG. 4B) is designed to accommodate for such part-to-part variations by precisely filing the gap 410. A variety of methods of providing such a spacer 418 are contemplated and within the present disclosure. FIG. 4C depicts an example where a spacer precursor material 422 is dispensed in the gap 410 via a dispensing system 420 (e.g., applicator gun, printhead, nozzle). The spacer precursor material 422 is beneficially a liquid material so that the material can take the precise shape of the gap 410. After application of the spacer precursor material 422, the spacer precursor material 422 is cured and solidified into the spacer 218 and beneficially extends an entirety of the distance between peripheral edge 414 and the inner edge 416.

A variety of materials can be used as the spacer precursor material 422. For example, in embodiments, the spacer 218 is relatively rigid. For example, in embodiments, the spacer 218 (after curing of the spacer precursor material 422) comprises a Young's modulus that is greater than that of the adhesive layer 66. In such embodiments, the spacer precursor material 422 may can comprise a Young's modulus greater than or equal to 100 MPa, greater than or equal to 300 MPa, greater than or equal to 500 MPa, greater than or equal to 800 MPa when cured so that the size of the gap 410 is maintained throughout the manufacturing process and applying force to either the frame 64 or back panel 408 will not cause the size of the gap 410 to change (once the spacer precursor material 422 has cured to an adequate degree). Suitably rigid materials include acrylic or epoxy-based adhesives.

As will be understood, curing of spacer precursor material 422 will depend on the type of material used to form spacer precursor material 422. In specific embodiments, the spacer precursor material 422 is a room temperature or thermally cured material, and the curing step involves application of temperature/heat to cure the spacer precursor material 422. In other specific embodiments, depending on the spacer precursor material 422, cure mechanisms could include radiation curing, change of pH, use of catalysts, activators or moisture. It is believed that 1K moisture cured or 2K adhesives would be particularly beneficial in that they may cure without the application of heat, thereby minimizing any harmful effects of heat on the components of the display module 404.

In embodiments, it may be beneficial if the spacer precursor material 422 comprises a relatively high viscosity when initially deposited (e.g., greater than or equal to 1 kcps, greater than or equal to 100 kcps, greater than or equal to 300 kcps). Such high viscosities facilitate the spacer precursor material 422 maintaining shape prior to completely curing so that the shape of the spacer 218 can be controlled.

In embodiments, the spacer precursor material 422 may include reaction injection molding materials. As used herein, “reaction injection molding materials” include thermosetting polymers that cure within a mold during an injection molding procedure (in this case, the gap 410 serves as the mold). In embodiments, reaction injection molding materials include polyurethane, polyureas, polyisocyanurates, polyesters, polyphenols, polyepoxides, and nylon 6. In embodiments, the spacer precursor material 422 may include reinforcing agents, such as glass fiber or mica. A two-component system of such materials may react and cure to form the spacer 418 with fast curing times. In embodiments, the spacer precursor material 422 may include a hot-melt adhesive including a suitable thermoplastic polymer, resin, plasticizer, and other additives. Such hot-melt adhesives may be beneficial in that they cure relatively quickly after dispensing and may maintain the shape of the gap 410 over the remaining time period that it takes the adhesive layer 66 to cure.

In embodiments, rather than being rigid, the spacer 218 can be constructed of a relatively compliant material that can be compressed to the size of the gap 410. In such embodiments, the spacer 218 may be formed of a material having a Young's modulus that is less than 100 MPa (e.g., less than or equal to 80 MPa, less than or equal to 50 MPa, less than or equal to 30 MPa, less than or equal to 10 MPa). In such embodiments, rather than being injected directly into the gap 410 as described above with respect to the rigid embodiments, the spacer 218 may initially be formed on one of the back panel 408 and frame 64 prior to the back panel 408 being attached to the glass substrate 52. To illustrate, FIG. 4D depicts an example where the back panel 408 is not yet attached to the glass substrate 52. While FIG. 4D depicts that the display layer 406 is disposed on the glass substrate 52 without the back panel 408, it should be appreciated that embodiments are also contemplated where the spacer 218 can be attached in a similar manner to the entire display module 404 (see FIG. 4B) prior to the display module 404 being laminated to the glass substrate 52 via the layer of optically clear adhesive 405. A force may be applied to the glass substrate 52 via the chuck 68 to maintain the glass in a bent state prior to the adhesive layer 66 curing, as described with respect to FIG. 4C.

As shown in FIG. 4D, the spacer 218 is attached to the peripheral edge 414 of the back panel 408 prior to the back panel 408 being lowered onto the glass substrate 52. In alternative embodiments, the spacer 218 can be attached to the inner edge 416 of the frame 64 rather than the peripheral edge 414. A variety of materials are contemplated for the spacer 218 in such embodiments. For example, the spacer 218 may be strips of pressure sensitive adhesive (e.g., 3M™ VHB™, such as #8412BLACK, #5909, #4611, #4930, #5952, Tesa®, such as #7805, #61057, or DAITAC STA400 or TRYCK). In embodiments, the spacer 218 may initially be deposited as a liquid precursor material and cured on the back panel 408 prior to the back panel 408 being lowered onto the glass substrate 52. In such embodiments, a suitable mold may be used to cure the liquid precursor material in a desired shape. Any suitable material that is compliant and can be compressed to fit the shape of the gap 410 can be used, including materials described above with respect to the adhesive layer 66 and the spacer precursor material 422.

In embodiments, as initially formed or deposited on the back panel 408, the spacer 218 comprises a thickness 424 measured in a direction perpendicular to the peripheral edge 414. The thickness 424 can be chosen to be greater than the width 412 of the gap 410 (the width 412 is the same as when the back panel 408 is disposed on the glass substrate 52, as the back panel 408 is aligned in a position that it will ultimately take on the glass substrate 52). As a result, lowering the back panel 408 onto the glass substrate 52 (e.g., into contact with the display layer 406 in the depicted embodiment) compresses the spacer 218 so that the spacer 218 takes on the exact shape of the gap 410, as shown in FIG. 4B). After such compression, the spacer 218 may apply an outward force that tends to maintain the size of the gap 410 and prevent deformation of the frame 64 and/or back panel 408 caused by relative motion throughout the fabrication process. In such embodiments, use of a pressure sensitive adhesive for the spacer 218 can be beneficial in that the spacer 218 can be bonded to both the peripheral edge 414 and inner edge 416 and not creep during the use of the display system 400.

With reference to FIGS. 4A-4D, the spacer 218 may have a variety of geometries. In embodiments, the spacer 218 only partially fills the gap 410. Such embodiments may include an air gap between the spacer 218 and the glass substrate 52 that may aid in hiding the appearance of the spacer 218 when the display system 400 is viewed from the first major surface 54. In embodiments, the spacer 218 is a continuous body that surrounds the entirety of the back panel 408. In embodiments, the spacer 218 comprises one or more discrete segments of material disposed in the gap 410 and extending an entirety of the distance between the peripheral edge 414 and inner edge 416. Any amount of material sufficient to maintain the dimensions and shape of the gap 410 when the back panel 408 is initially disposed on the glass substrate 52 can be used.

In embodiments, after the spacer 218 is formed in the gap 410 (and the precursor material of the spacer 218 is cured), the back panel 408 may maintain the glass substrate 52 in a desired curved shape even if the adhesive layer 66 is not completely cured. This may particularly happen in embodiments where the material of the spacer 218 cures prior to the adhesive layer 66. As a result, the force applied to the glass substrate 52 to initially bend the glass substrate 52 can be removed prior to the adhesive layer being 66 completely cured. This is aided by the spacer 218 maintaining the relative positioning between the frame 64 and the display module 404. Such early removal can free up equipment used in fabrication and increase process throughput. In the depicted embodiment, for example, the display system 400 can be removed from the chuck 68 and placed in a staging area to allow the adhesive layer 66 to cure. This allows another system to be fabricated using the chuck 68 while the adhesive layer 66 cures.

In addition to the spacers described herein, various other features can be incorporated into the display system 400 and the fabrication thereof to alleviate issues caused by variability in the shape of the frame. A plurality of such features will now be described. It should be understood that such features can be used in addition to the spacer 218 to provide even greater control over the adhesive during the fabrication process or used individually. While the display system 400 described with respect to FIGS. 4A-4D is used as an example system that can incorporate the features described below, it should be understood that other display systems (having different components, forms, and/or shapes) can also incorporate these features.

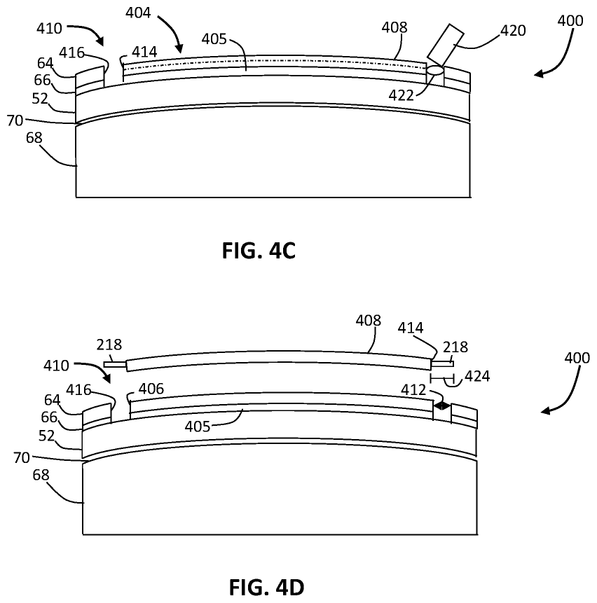

In embodiments, material can be incorporated in between the glass substrate 52 and frame 64 to control the adhesive. FIG. 5 depicts an embodiment that incorporates a spacing element 500 between the glass substrate 52 and the frame 64. The spacing element 500 is disposed at a periphery of the curved support surface 65 and serves to perform at least one of the following functions: (a) hide the adhesive layer 66 from view so that the wavy appearance caused by the variable shape of the frame 64 is not visible; (b) serve as a dam to prevent the material of the adhesive layer 66 from overflowing outward when compressed during the fabrication process; and (c) set the thickness of the adhesive layer 66.

A variety of materials may be used to construct the spacing element 500. In embodiments, the spacing element 500 may be formed of strips of a pressure sensitive adhesive and function as described in U.S. patent application Ser. No. 17/295,742, entitled “Adhering Glass Cover Sheet to a Frame,” hereby incorporated by reference in its entirety. In such embodiments, the spacing element 500 can aid in maintaining the curved shape of the glass substrate 52 as the adhesive layer 66 cures, thereby allowing cold-forming processes other than a vacuum chuck to be used. For example, a roller, preform, mold, clamping structure or other suitable structure can be used to press the glass substrate 52 against the frame 64, and the spacing element 500 can bond the glass substrate 52 to the frame 64 and hold the glass substrate 52 in the curved shape as the adhesive layer 66 cures.

In embodiments, the spacing element 500 is positioned adjacent the adhesive layer 66 and can be used to impart force on the glass substrate 52 as the frame 64 is positioned on the glass substrate 52 during cold-forming (e.g., the spacing element 500 may cause the glass substrate 52 to bend in conformity with the forming surface 70 of the chuck 68 depicted in FIGS. 4C and 4D). Use of the spacing element 500 can result in a uniform application of force irrespective of frame irregularities and control the thickness of the adhesive layer 66. In embodiments, for example, the spacing element 500 can be a rigid material (e.g., metal, ceramic, composite, polymeric) bonded to at least one of the glass substrate 52 or frame 64. In embodiments, the spacing element 500 is a projection of the curved support surface 65 of the frame 64 (e.g., the spacing element 500 can be integrally formed with the frame 64 during the casting process). In embodiments, the spacer is a compliant material such as rubber or a gasket material.

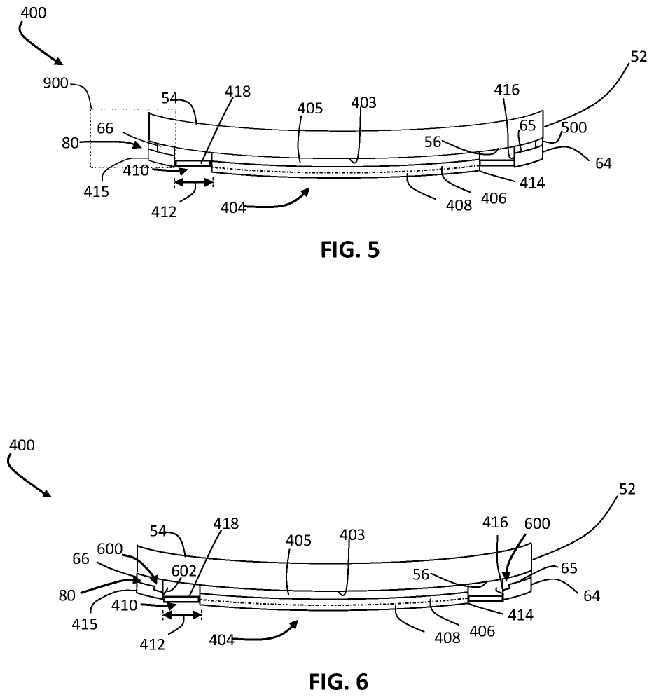

As an alternative or in addition to the spacing element 500, the frame 64 can be modified so accommodate adhesive overflow towards the inside of the display system 400 (inward of the inner edge 416). FIG. 6 shows an example where the curved support surface 65 comprises a step 600 extending outward from the inner edge 416. The step 600 provides space for excess adhesive to flow into to prevent overflow into the gap 410. In embodiments, rather than the step 600, the frame 64 can comprise a depression or through hole that is offset from the inner edge 416 to provide a space for excess adhesive flow. The step 600, hole, or depression may function in the manner of the openings described in U.S. patent application Ser. No. 17/263,378, entitled “Cold-formed Curved Glass Articles and Methods of Making the Same,” hereby incorporated by reference in its entirety. Particularly, the step 600, hole, or depression can improve bonding between the glass substrate 52 and frame 64 and improve impact performance.

In addition to or instead of the step 600, the display system 400 can further include a trough 602 disposed inward of the inner edge 416. The trough 602 can collect inward overflow of adhesive and prevent the adhesive from interacting with other components of the display system 400. In embodiments, the trough 602 is formed integrally with the frame 64. In embodiments, the trough is a separate component to the frame 64 (e.g., formed of a different material than the main body of the frame 64). In embodiments, the trough 602 extends above the curved support surface 65 to completely prevent any inward adhesive overflow. In embodiments, the trough 602 is an extension (e.g., protrusion, bump, cantilevered portion) of the inner edge 416 and prevents droplets of excess adhesive from reaching other components.

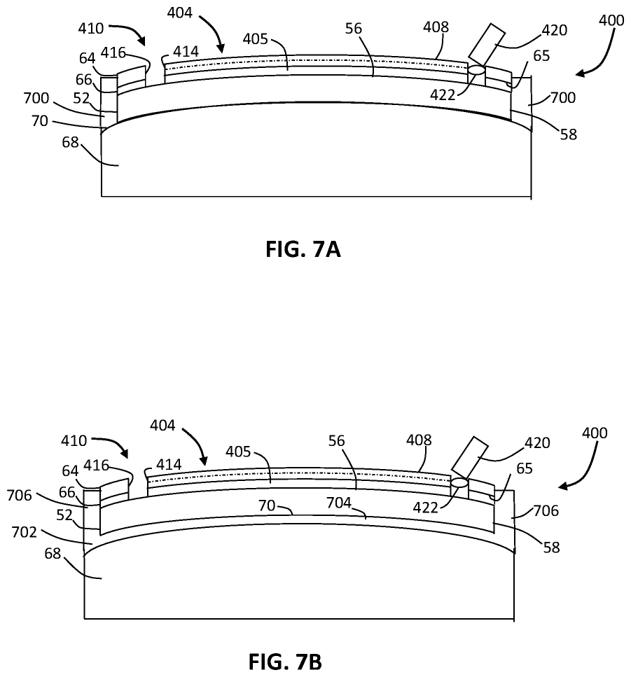

In embodiments, the adhesive can be controlled through modifying the fabrication process. Adhesive shaping elements can be added to components used to cold-form the glass substrate. For example, FIG. 7A depicts an example where a shaping element 700 is disposed on the forming surface 70 of the chuck 68. In embodiments, the shaping element 700 contacts the minor surface 58 of the glass substrate 52 and extends beyond the second major surface 56 so that the shaping element 700 acts a dam for the adhesive layer 66 and prevents overflow. In embodiments, the shaping element 700 extends from the forming surface 70 to the curved support surface 65 (e.g., the minor surface 58 may be offset from the periphery of the frame in such embodiments to provide space for the shaping element 700 to contact the curved support surface 65). In such embodiments, the shaping element 700 may serve both as a dam to prevent adhesive overflow and serve as a spacer to control a thickness of the adhesive layer 66. The shaping element 700 may be removable from the chuck 68 (and from between the frame 64 and the forming surface 70) so that, after the adhesive layer 66 is cured, an adhesive layer of uniform appearance is produced and the shaping element 700 does not add bulk to the display system 400.

In embodiments, the shaping element 700 is integrated or attached to the chuck 68. For example, FIG. 7B depicts an embodiment where a shaping element 702 forms at least a portion of the forming surface 70 of the vacuum chuck 68. As shown, the shaping element 702 comprises a supporting portion 704 and a side portion 706. The supporting portion 704 may be disposed on the main body of the chuck 68 and form the forming surface 70 that contacts the glass substrate 52. The side portion 706 may extend from the supporting portion 704 and define a cavity into which the glass substrate 52 is disposed during cold-forming. The side portion 706 may have a shape that corresponds to a peripheral shape of the glass substrate 52 so that the side portion 706 facilitates aligning the glass substrate 52. The side portion 706 may contact the minor surface 58 of the glass substrate 52 and extend beyond the second major surface 56 to form a dam for the adhesive layer 66. Integrating the shaping element 702 into the chuck 68 may enable consistent alignment of components from part to part and reduce process variability.

By utilizing the spacer 218 described with respect to FIGS. 4A-4C in combination with at least one of the spacing element 500, step 600, trough 602, and one of the shaping elements 700 and 702, it is believed adhesive overflow during fabrication can be prevented and the adhesive layer 66 can have a uniform thickness despite variations in the shape of the frame 64. As described herein, the spacer 218 prevents deformation of the frame 64 and back panel 408 during the fabrication process and allows for more uniform spacing between the frame 64 and the glass substrate 52. The spacing element 500 and/or shaping elements 700 and 702 can further aid in shaping the adhesive layer by preventing adhesive overflow and controlling the thickness of the adhesive layer 66. The step 600 and/or trough 602 can be used in combination with the spacer 218 (and also optionally in combination with the spacing element 500 and/or one of shaping elements 700 and 702) to prevent adhesive overflow to the inside of the frame 64. Varying amounts of adhesive control can therefore be provided by incorporating any number of the features described herein in combination with one another.

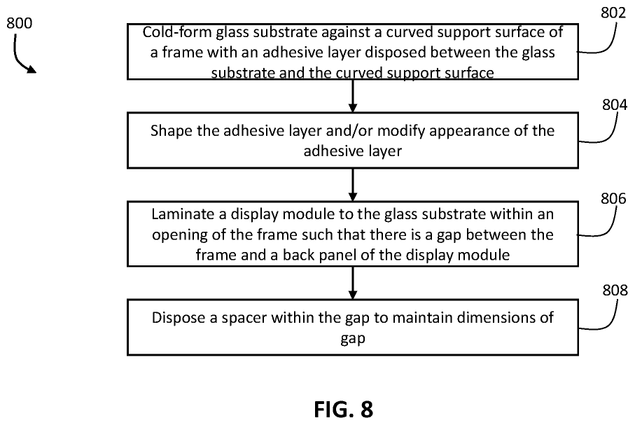

Referring now to FIG. 8, a process 800 of fabricating a display system is shown, according to an example embodiment. The process 800 may be used to fabricate the display system 400 described herein, in accordance with any of the embodiments described with respect to FIGS. 2A-7B. Accordingly, reference will be made to various components depicted in FIGS. 2A-7B to aid in the description of the method. It should be understood that the process 800 can be used in the fabrication of display systems having different shapes and configurations than the display system 400 described herein.

At block 802, the glass substrate 52 is cold-formed against the curved support surface 65 of the frame 64 with the adhesive layer 66 disposed between the glass substrate 52 and the curved support surface 65. As described herein, a variety of different processes can be used to cold-form the glass substrate 52. Generally, cold-forming involves applying a bending force to the glass substrate 52 to bend the glass substrate 52 into a curved shape (the glass substrate 52 may initially be a planar sheet of glass cut to a suitable size and shape). In embodiments, the bending force is applied via a vacuum chuck, such as the chuck 68 described herein. In embodiments, the spacing element 500 may be disposed between the glass substrate 52 and the frame 64. For example, the spacing element 500 may be disposed on and attached to one of the second major surface 56 and the curved support surface 65 prior to the glass substrate 52 being pressed against the frame 64. The spacing element 500 determines the spacing between the glass substate 52 and frame 64 and allows the bending force to be applied via the frame 64 rather than via the chuck 68 (though embodiments are envisioned where the spacing element 500 is used in conjunction with the chuck 68 so that the adhesive layer 66 has a uniform thickness after curing). In embodiments including the spacing element 500 (or other spacing element controlling the distance between the frame 64 and glass substrate 52), the bending force can be applied via a vacuum bag (e.g., the glass substrate 52 and frame 64 can be inserted to the vacuum bag with adhesive disposed on one of the glass substrate 52 and frame). Alternatively, the bending force may be applied by contacting the glass substrate 52 with a roller, preform, or mold to conform the glass substrate 52 with the curved support surface 65. Alternately, the bending force is applied by clamping the glass substrate 52 to the frame 64 with a plurality of clamps. The roller, preform, mold, and clamps may also be used in combination with the chuck 68.

Prior to the cold-forming, the adhesive of the adhesive layer 66 can be dispensed on the curved support surface 65 or the second major surface 56. For example, the nozzle 71 may be moved along a bead path in a shape corresponding to the frame 64 to dispense the adhesive in a desired pattern. As described herein, the deposition rate of the adhesive along the bead path can be controlled based on the shape of the frame 64. Areas where the frame 64 is smaller than expected and/or where there are bumps on the curved support surface 65 may be provided with smaller volumes of adhesive than areas of the frame 64 that are larger and/or where there are troughs on the curved support surface 65.

At block 804, the adhesive layer 66 is shaped and/or modified in appearance. In embodiments, when the adhesive layer 66 is compressed between the frame 64 and the glass substrate 52, excess adhesive material may overflow either outward or inward from the frame 64 (especially in embodiments not including the spacing element 500, where the adhesive is not shaped with one of the shaping elements 700 and 702, the step 600, or the trough 602). Such excessive adhesive can be removed (e.g., scraped) from the frame 64 prior to curing and prior to interacting with any other additional components. In embodiments, excess adhesive can be cut after curing to control the appearance of the adhesive layer 66. In embodiments, the adhesive layer 66 can be shaped via incorporating the spacing element 500, step 600, and/or trough 602 described herein with respect to FIGS. 5-6. In embodiments, the adhesive layer 66 can be shaped via an external shaping element such as the shaping elements 700 and 702 described herein with respect to FIGS. 7A-7B.

In embodiments, the appearance of the adhesive layer 66 can be modified to be less glossy and noticeable, thereby rendering waviness less noticeable in the display system 400. In embodiments, after the adhesive layer 66 is cured, the adhesive layer 66 can be texturized to provide a matte finish. The adhesive layer 66 can be textured via any suitable method. In embodiments, the adhesive layer 66 can be textured by treating the adhesive while the adhesive is uncured by, for example, jetting air onto the adhesive layer 66, spraying the adhesive layer 66 with water, applying a textured roller or sponge to the adhesive layer 66, or other suitable technique. Such treatments can cause the adhesive layer 66 layer to scatter incident light (e.g., have a reflection haze greater than or equal to 20%) and be less glossy and noticeable.

At block 806, the display module 404 is laminated to the glass substrate 52 within the opening 402 defined by the frame 64 such that the gap 410 is disposed between the frame 64 and the back panel 408 of the display module 404. Any suitable method may be used to apply the layer of optically clear adhesive 405 and to press the display module 404 against the second major surface 56. At block 808, the spacer 218 is disposed in the gap 410 via any of the methods described herein.

A discussion of the properties of embodiments of the glass substrate 52 are provided below. Thus, in the following paragraphs, various geometrical, mechanical, and strengthening properties of the glass substrate 52 as well as compositions of the glass substrate 52 are provided.

In various embodiments, the average thickness T of the glass substrate 52 between the first major surface 54 and the second major surface 56 is in the range of 0.3 mm to 2 mm. In various embodiments, the width of the glass substrate 52 is in a range from 5 cm to 250 cm. Further, in various embodiments, the length of the glass substrate 52 is in a range from 5 cm to 1500 cm. The length is the maximum dimension of the glass substrate 52 perpendicular to the thickness T. The width is the maximum dimension of the glass substrate 52 perpendicular to the thickness T and the length. In various embodiments, one or more radius of curvature (e.g., R shown in FIGS. 2A-2B) of glass substrate 52 is from 75 mm to 10,000 mm.

In one or more embodiments, glass substrate 52 may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress. In various embodiments, glass substrate 52 may be strengthened mechanically by utilizing a mismatch of the coefficient of thermal expansion between portions of the article to create a compressive stress region and a central region exhibiting a tensile stress. In some embodiments, the glass sheet may be strengthened thermally by heating the glass to a temperature above the glass transition point and then rapidly quenching.

In still other embodiments, the glass substrate 52 is chemically strengthened through an ion exchange process. In the ion exchange process, ions at or near the surface of the glass sheet are replaced by—or exchanged with—larger ions having the same valence or oxidation state. In those embodiments in which the glass sheet comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass sheet generate a stress.

Ion exchange processes are typically carried out by immersing a glass sheet in a molten salt bath (or two or more molten salt baths) containing the larger ions to be exchanged with the smaller ions in the glass sheet. It should be noted that aqueous salt baths may also be utilized. In addition, the composition of the bath(s) may include more than one type of larger ions (e.g., Na+ and K+) or a single larger ion. It will be appreciated by those skilled in the art that parameters for the ion exchange process, including, but not limited to, bath composition and temperature, immersion time, the number of immersions of the glass sheet in a salt bath (or baths), use of multiple salt baths, additional steps such as annealing, washing, and the like, are generally determined by the composition of the glass sheet (including the structure of the article and any crystalline phases present) and the desired DOC and compressive stress (CS) of the glass sheet that results from strengthening. Exemplary molten bath compositions may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass sheet thickness, bath temperature and glass (or monovalent ion) diffusivity. However, temperatures and immersion times different from those described above may also be used.

In one or more embodiments, the glass sheets may be immersed in a molten salt bath of 100% NaNO₃, 100% KNO₃, or a combination of NaNO₃ and KNO₃ having a temperature from about 370° C. to about 480° C. In some embodiments, the glass sheet may be immersed in a molten mixed salt bath including from about 5% to about 90% KNO₃ and from about 10% to about 95% NaNO₃. In one or more embodiments, the glass sheet may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass sheet may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass sheet. The spike may result in a greater surface CS value. This spike can be achieved by a single bath or multiple baths, with the bath(s) having a single composition or mixed composition, due to the unique properties of the glass compositions used in the glass sheets described herein.

In one or more embodiments, where more than one monovalent ion is exchanged into the glass sheet, the different monovalent ions may exchange to different depths within the glass sheet (and generate different magnitudes stresses within the glass sheet at different depths). The resulting relative depths of the stress-generating ions can be determined and cause different characteristics of the stress profile.

CS can be measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method.

DOC may be measured by FSM or by a scattered light polariscope (SCALP) (such as the SCALP-04 scattered light polariscope available from GlasStress Ltd., located in Tallinn Estonia), depending on the strengthening method and conditions. When the glass sheet is chemically strengthened by an ion exchange treatment, FSM or SCALP may be used depending on which ion is exchanged into the glass sheet. Where the stress in the glass sheet is generated by exchanging potassium ions into the glass sheet, FSM is used to measure DOC. Where the stress is generated by exchanging sodium ions into the glass sheet, SCALP is used to measure DOC. Where the stress in the glass sheet is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass sheets is measured by FSM. CT is the maximum tensile stress and is measured by SCALP.

Suitable glass compositions for use in glass substrate 52 include soda lime glass, aluminosilicate glass, borosilicate glass, boroaluminosilicate glass, alkali-containing aluminosilicate glass, alkali-containing borosilicate glass, and alkali-containing boroaluminosilicate glass.

In one or more embodiments, the glass composition may include SiO₂ in an amount in a range from about 66 mol% to about 80 mol%, Al₂O₃ in an amount in a range from about 4 mol% to about 15 mol%, B₂O₃ in an amount in a range from about 0 mol% to about 5 mol%, P₂O₅ in an amount in a range from about 0 mol% to about 2 mol%, R₂O in an amount in a range from about 8 mol% to about 20 mol%, RO in an amount in a range of from about 0 mol% to about 2 mol%, ZrO₂ in an amount in a range of from about 0 mol% to about 0.2 mol%, and SnO₂ in an amount in a range from about 0 mol% to about 0.2 mol%. In the foregoing composition, R₂O refers to the total amount of alkali metal oxides, such as Li₂O, Na₂O, K₂O, Rb₂O, and Cs₂O). In particular, Na₂O may be present in an amount in a range from about from about 8 mol% to about 20 mol%, and K₂O may be present in an amount in a range from about 0 mol% to about 4 mol%. Further, in the foregoing composition, RO refers to the total amount of alkaline earth metal oxide such, as CaO, MgO, BaO, ZnO and SrO. In particular, CaO may be present in an amount in a range of from about 0 mol% to about 1 mol%, and MgO may be present in an amount in a range of from about 0 mol% to about 7 mol%.

In embodiments, the glass composition may include other oxides of such metals as Ti, V, Cr, Mn, Fe, Co, Ni, Cu, Ce, W, and Mo. In particular, Fe in the form of Fe₂O₃ may be present in an amount in a range of from about 0 mol% to about 1 mol%, and TiO₂ may be present in an amount of in a range of about 0 mol% to about 5 mol%.

An exemplary glass composition includes SiO₂ in an amount in a range from about 65 mol% to about 75 mol%, Al₂O₃ in an amount in a range from about 8 mol% to about 14 mol%, Na₂O in an amount in a range from about 12 mol% to about 17 mol%, K₂O in an amount in a range of about 0 mol% to about 0.2 mol%, and MgO in an amount in a range from about 1.5 mol% to about 6 mol%. Optionally, SnO₂ may be included in the amounts otherwise disclosed herein.

Embodiments of the present disclosure may be further understood in view of the following information.

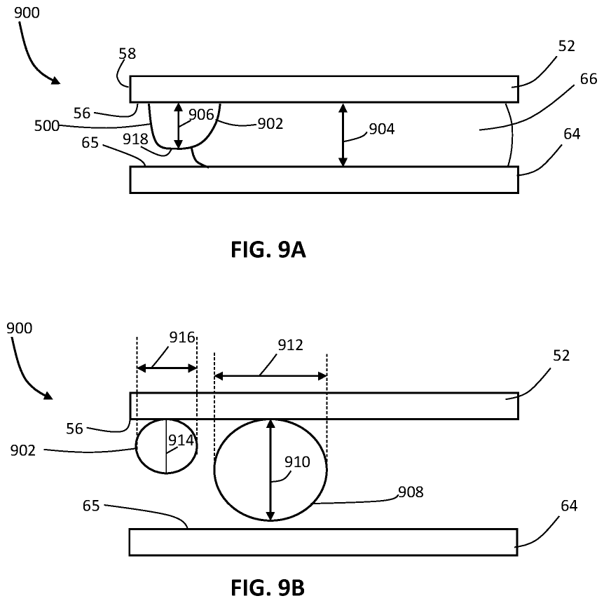

As described herein with respect to FIG. 5, embodiments of the present disclosure may include a spacing element 500 disposed on one of the frame 64 or glass substrate 52 that can be configured to act as a dam to prevent overflow of the material of the adhesive layer 66 when compressed to bond the frame 64 to the glass substrate 52. Further aspects of an example embodiment of such a spacing element 500 are described herein with respect to FIGS. 9A-9B. FIG. 9A schematically depicts a cross-sectional view of a region 900 of the display system 400 depicted in FIG. 5, according to an example embodiment. In this embodiment, the spacing element 500 comprises a secondary adhesive bead 902 disposed proximate to a peripheral edge of the frame 64 and/or the minor surface 58 of the glass substrate 52. The secondary adhesive bead 902 is in contact with the adhesive layer 66 and serves to prevent the material of the adhesive layer 66 from flowing outward as the material of adhesive layer 66 is compressed during any of the manufacturing processes described herein. FIG. 9A depicts the secondary adhesive bead 902 and adhesive layer 66 in a fully cured state. As shown, when fully cured, the adhesive layer 66 comprises a thickness 904 that corresponds to a separation distance between the second major surface 56 and the frame 64 so that the adhesive layer 66 bonds the glass substrate 52 to the frame 64 and maintains the separation distance therebetween.

In embodiments, the secondary adhesive bead 902 is formed of the same material as the adhesive layer 66 and is dispensed and cured by similar processes. In embodiments, the nozzle 71 depicted in FIG. 3 can be used to dispense both the secondary adhesive bead 902 and the adhesive layer 66. FIG. 9B schematically depicts the portion 900 during fabrication prior to the adhesive layer 66 being compressed according to an example embodiment. As shown in FIG. 9B, the nozzle 71 can be used to dispense the secondary adhesive bead 902 along a first bead path at the periphery of one of the glass substrate 52 and the frame 64. In embodiments, the nozzle 71 can also be used to dispense a primary adhesive bead 908—an uncured, uncured predecessor to the adhesive layer 66 depicted in FIG. 9A—along a second bead path that is inside of the first bead path after the secondary adhesive bead 902 is at least partially cured. In embodiments, active steps are taken to cure the secondary adhesive bead 902 (e.g., heating, exposure to radiation, time delay, exposure to a curing component) prior to dispensing the primary adhesive bead 908. In embodiments, the secondary adhesive bead 902 is at least partially cured after dispensing thereof is completed (e.g., an initially dispensed portion may be partially cured prior to the secondary adhesive bead 902 being disposed along the entirety of the first bead path) and dispensing of the primary adhesive bead 908 can begin immediately after the dispensing of the secondary adhesive bead 902 is complete. Using the same material for the primary and secondary adhesive beads 908 and 902 beneficially enables the same dispensing equipment to be used for each bead and may streamline the fabrication process.

The nozzle 71 can be controlled during dispensing of the primary adhesive bead 908 and the secondary adhesive bead 902 so that each bead has a desired volume. As depicted in FIG. 9B, when uncured, the primary adhesive bead has a thickness 910 measured in a direction perpendicular to the surface on which it is dispensed (the second major surface 56 in this example) and a width 912 measured in a direction parallel to the surface; and the secondary adhesive bead 902 has a thickness 914 and a width 916. In embodiments, the secondary adhesive bead 902 comprises a smaller volume than the primary adhesive bead 908 so that the width 916 is less than the width 912 and the thickness 914 is less than the thickness 910. As described herein, during assembly of the display system 400, it is beneficial to compress the primary adhesive bead 908 so that the adhesive material contacts relatively large areas of the glass substrate 52 and frame 64 prior to curing to facilitate formation of a reliable bond. To facilitate such compression, the thickness 910 of the primary adhesive bead 908 may be greater than the thickness 904 of the adhesive layer 66 after the fabrication thereof (see FIG. 9A).

In embodiments, the thickness 914 of the secondary adhesive bead 902 is less than or equal to the thickness 904 (see FIG. 9A) to enable compression of the primary adhesive bead 908. In order for the secondary adhesive bead 902 to effectively act as a dam to prevent uncured adhesive of the primary adhesive bead 908 from flowing outward after compression of the primary adhesive bead 908, the secondary adhesive bead 902 is partially cured when the primary adhesive bead 908 is dispensed, and therefore has some degree of rigidity. As a result of being cured, the secondary adhesive bead 902 may prevent compression of the primary adhesive bead 908 to some extent. As such, to allow the primary adhesive bead 908 to obtain the desired thickness 904 after compression, the height of the secondary adhesive bead 902 is less than or equal to the thickness 904. In embodiments, the thickness 914 is greater than or equal to 50% of the thickness 910 and less than or equal to 80% of the thickness 910 to permit an adequate amount of compression of the primary adhesive bead 908 while still providing a dam of adequate height for effectively preventing overflow of material of the primary adhesive bead 908 upon compression. When the thickness 914 is equal to the thickness 904, the secondary adhesive bead 902 may function to determine the thickness 904 by limiting the amount that the primary adhesive bead 908 can be compressed. Such a configuration may beneficially provide a uniform thickness for the adhesive layer 66, irrespective of shape irregularities of the frame 64.

A variety of configurations for the primary adhesive bead 908 and the secondary adhesive bead 902 are contemplated and within the scope of the present disclosure. In embodiments, the primary adhesive bead 908 and the secondary adhesive bead 902 comprise uniform cross-sectional dimensions around the periphery of the frame 64. For example, the primary adhesive bead 908 and the secondary adhesive bead 902 may each comprise a plurality of linear segments that follow corresponding segments of the peripheral shape of the glass substrate 52 and frame 64. Any suitable cross-sectional dimensions can be used for the beads. For example, in embodiments, the width 912 is greater than the thickness 910 and the width 916 is greater than the thickness 914. Having relatively large widths may promote reliable bonds through increased bonding area. In embodiments, the width 912 is larger than the width 916. The secondary adhesive bead 902 may not bond to both of the frame 64 and the glass substrate 52; and so the width 916 thereof is not particularly limiting. However, rendering the width 916 as small as possible while still being able to achieve a desired value for the thickness 914 can beneficially save adhesive material and also maximize the available bonding area for the adhesive layer 66. In embodiments, the thickness 910 of the primary adhesive bead 908 is at least 110% of the thickness 904 of the adhesive layer 66 (e.g., greater than or equal to 120% of the thickness 904 and less than or equal to 130% of the thickness 904) after the fabrication process is complete (see FIG. 9A). to allow an adequate amount of compression.

Referring again to FIG. 9A, as a result of the secondary adhesive bead 902 being at least partially cured when the primary adhesive bead 908 is compressed, the secondary adhesive bead 902 may include an unbonded surface 918 that is not directly bonded to either of the glass substrate 52 or the frame 64. In the depicted example, the unbonded surface 918 is not in contact with the frame 614 (so that there is an air gap between the secondary adhesive bead 902 and the frame 64). It has been found that such an air gap does not prevent the secondary adhesive bead 902 from effectively functioning as a dam preventing overflow of the primary adhesive bead 908 upon compression, provided that a thickness 906 of the secondary adhesive bead 902 after the fabrication process is at least 50% of the thickness 904 of the adhesive layer 66. It has been found that the secondary adhesive bead 902 tends to force the adhesive of the primary adhesive bead 908 inward and prevents overflow even with the presence of the air gap. In embodiments, the thickness 906 can be equal to the thickness 904, indicating contact between the unbonded surface 918 and the frame 64 or glass substrate 52. Such embodiments without an air gap may signify use of the secondary adhesive bead 902 in setting the desired thickness 904 by limiting the compression of the primary adhesive bead 908.

Embodiments of the present disclosure may be further understood in view of the following aspects.

An aspect (1) of the present disclosure pertains to a display system comprising: a glass substrate comprising a first major surface and a second major surface; a frame comprising a curved support surface, the frame comprising an inner edge defining an opening; an adhesive layer disposed between the curved support surface and the second major surface and attaching the glass substrate to the frame to conform the glass substrate to the curved support surface, wherein the second major surface comprises an open region that is not adhered to the frame and overlaps the opening; a display module disposed in the opening and adhered to the open region, wherein the display module comprises a display layer and a back panel, wherein there is a gap disposed between a peripheral edge of the back panel and the inner edge, wherein the frame is not bolted to the back panel; and a spacer disposed in the gap and extending an entirety of a distance between the peripheral edge and the inner edge.

An aspect (2) of the present disclosure pertains to a display system according to the aspect (1), wherein the gap surrounds an entirety of the peripheral edge of the back panel.

An aspect (3) of the present disclosure pertains to a display system according to any of the aspects (1)-(2), wherein the back panel comprises a backlight unit or a heatsink that is curved and comprises a surface with a minimum radius of curvature that is within 10% of that of the curved support surface.

An aspect (4) of the present disclosure pertains to a display system according to any of the aspects (1)-(3), wherein the spacer partially fills the gap.

An aspect (5) of the present disclosure pertains to a display system according to any of the aspects (1)-(4), wherein the spacer comprises at least one of polyurethane, a polyurea, a polyisocyanurate, a polyester, a polyphenol, a polyepoxide, nylon 6, a 1K component adhesive or sealant, and a 2K component adhesive or sealant.

An aspect (6) of the present disclosure pertains to a display system according to any of the aspects (1)-(5), wherein the spacer comprises a Young's modulus that is greater than 100 MPa.

An aspect (7) of the present disclosure pertains to a display system according to any of the aspects (1)-(5), wherein the spacer comprises a Young's modulus that is less than or equal to 50 MPa and is compressed inside the gap.

An aspect (8) of the present disclosure pertains to a display system according to any of the aspects (1)-(7), wherein the curved support surface comprises: a length that is greater than or equal to 500 mm and less than or equal to 3000 mm; a width that is less than half of the length; and a minimum radius of curvature that is greater than or equal to 100 mm and less than or equal to 1500 mm.

An aspect (9) of the present disclosure pertains to a display system according to any of the aspects (1)-(8), further comprising at least one of: a spacing element disposed between the curved support surface and the second major surface proximate to a periphery of the second major surface, a step or through-hole on the curved support surface, and a trough extending from the inner edge of the frame.

An aspect (10) of the present disclosure pertains to a display system according to any of the aspects (1)-(9), wherein an outer surface of the adhesive layer is texturized.

An aspect (11) of the present disclosure pertains to a method of forming a display system, the method comprising: cold-forming a glass substrate against a curved support surface of a frame with an adhesive layer disposed between the curved support surface and the glass substrate, wherein the frame comprises an opening; laminating a display module to the glass substrate within the opening via a layer of optically clear adhesive, wherein the display module comprises a back panel and wherein a peripheral edge of the back panel is separated from an interior edge of the frame by a gap; disposing a spacer in the gap, wherein the spacer bonds the back panel to the frame and maintains a shape of the gap; and curing the adhesive layer such that the glass substrate is retained in a curved shape by the frame.

An aspect (12) of the present disclosure pertains to a method according to the aspect (11), wherein the cold-forming comprises: applying a negative pressure to the glass substrate via a vacuum chuck to conform the glass substrate against the vacuum chuck; and pressing the curved support surface against the glass substrate after the negative pressure is applied to the glass substrate.

An aspect (13) of the present disclosure pertains to a method according to the aspect (12), wherein: the back panel is curved prior to be laminated to the glass substrate, and the spacer bonds the back panel to the frame prior to the adhesive layer being cured.

An aspect (14) of the present disclosure pertains to a method according to the aspect (13), further comprising, prior to the adhesive layer being cured, removing the glass substrate, frame, and display module from the vacuum chuck, wherein the back panel retains the glass substrate in the curved shape prior to the adhesive being fully cured.

An aspect (15) of the present disclosure pertains to a method according to any of the aspects (11)-(14), wherein disposing the spacer comprises injecting spacer precursor material into the gap and curing the spacer precursor material.

An aspect (16) of the present disclosure pertains to a method according to any of the aspects (11)-(14), wherein disposing the spacer comprises attaching the spacer to the peripheral edge or the interior edge prior to laminating the display module to the glass substrate.

An aspect (17) of the present disclosure pertains to a method according to any of the aspects (11)-(16), wherein the cold-forming comprises dispensing adhesive of the adhesive layer on one of a curved support surface of the frame and glass substrate along a bead path, wherein the bead path comprises a shape that corresponds to a shape of a curved support surface of the frame.

An aspect (18) of the present disclosure pertains to a method according to the aspect (17), wherein dispensing the adhesive comprises controlling a dispensing rate of the adhesive as a function of a shape of the curved support surface.

An aspect (19) of the present disclosure pertains to a method according to any of the aspects (17)-(18), further comprising attaching a spacing element to one of the frame and the glass substrate prior to dispensing the adhesive, the spacing element configured to prevent the adhesive from flowing outward of the frame when the adhesive is compressed between the glass substrate and the frame.

An aspect (20) of the present disclosure pertains to a method according to any of the aspects (17)-(18), further comprising shaping the adhesive when the adhesive is compressed between the glass substrate and the frame via an adhesive shaping element disposed outward of the glass substrate.

An aspect (21) of the present disclosure pertains to a display system comprising: a glass substrate comprising a first major surface and a second major surface; a frame comprising a curved support surface, the frame defining an opening; an adhesive layer disposed between the curved support surface and the second major surface and attaching the glass substrate to the frame to conform the glass substrate to the curved support surface, wherein the second major surface comprises an open region that is not adhered to the frame and overlaps the opening; a display module disposed in the opening and adhered to the open region, wherein the display module comprises a display layer and a back panel, wherein there is a gap disposed between a peripheral edge of the back panel and an inner edge of the frame, wherein the frame is not bolted to the back panel; a spacer disposed in the gap and extending an entirety of a distance between the peripheral edge and the inner edge; and at least one of: a spacing element disposed between the curved support surface and the second major surface proximate to a periphery of the second major surface, a step or through-hole on the curved support surface, and a trough extending from the inner edge of the frame.

An aspect (22) of the present disclosure pertains to a display system according to the aspect (21), wherein the back panel comprises a backlight unit or a heatsink that is curved and comprises a surface with a minimum radius of curvature that is within 10% of that of the curved support surface.

An aspect (23) of the present disclosure pertains to a display system according to any of the aspects (21)-(22), wherein the spacer partially fills the gap.

An aspect (24) of the present disclosure pertains to a display system according to any of the aspects (21)-(23), wherein the spacer comprises at least one of polyurethane, a polyurea, a polyisocyanurates, a polyester, a polyphenol, a polyepoxide, nylon 6, a 1K component adhesive or sealant, and a 2K component spacer or sealant.

An aspect (25) of the present disclosure pertains to a display system according to any of the aspects (21)-(24), wherein the spacer comprises a Young's modulus that is greater than 100 MPa.

An aspect (26) of the present disclosure pertains to a display system according to any of the aspects (21)-(24), wherein the spacer comprises a Young's modulus that is less than or equal to 50 MPa and is compressed inside the gap.

An aspect (27) of the present disclosure pertains to a display system according to any of the aspects (21)-(26), wherein the curved support surface comprises: a length that is greater than or equal to 500 mm and less than or equal to 3000 mm; a width that is less than half of the length; and a radius of curvature that is greater than or equal to 100 mm and less than or equal to 1500 mm.

An aspect (28) of the present disclosure pertains to a display system according to any of the aspects (21)-(27), wherein an outer surface of the adhesive layer is texturized.

An aspect (29) of the present disclosure pertains to a display system according to the aspect (9), wherein the display system comprises the spacing element and the spacing element comprises a secondary adhesive bead comprising an unbonded surface that is not directly bonded to either the curved support surface or the second major surface.

An aspect (30) of the present disclosure pertains to a method according to any of the aspects (17)-(18), wherein: the adhesive of the adhesive layer is disposed along a first bead path in the form of a primary adhesive bead comprising a first thickness measured in a direction perpendicular to a surface upon which the primary adhesive bead is disposed and a first width measured in a direction parallel to the surface, the method further comprises, prior to dispensing the adhesive of the adhesive layer, dispensing a secondary adhesive bead along a second bead path surrounding the first bead path, the secondary adhesive bead comprises a second thickness that is less than the first thickness of the primary adhesive bead when the primary adhesive bead is dispensed, and the secondary adhesive bead is at least partially cured when the adhesive of the adhesive layer is dispensed.

An aspect (31) of the present disclosure pertains to a method according to the aspect (30), wherein the second thickness is less than or equal to a thickness of the adhesive layer after the curing the adhesive.

An aspect (32) of the present disclosure pertains to a display system according to any of the aspects (21)-(28), wherein the display system comprises the spacing element and the spacing element comprises a secondary adhesive bead comprising an unbonded surface that is not directly bonded to either the curved support surface or the second major surface.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A display system comprising:
a glass substrate comprising a first major surface and a second major surface;
a frame comprising a curved support surface, the frame comprising an inner edge defining an opening;
an adhesive layer disposed between the curved support surface and the second major surface and attaching the glass substrate to the frame to conform the glass substrate to the curved support surface, wherein the second major surface comprises an open region that is not adhered to the frame and overlaps the opening;
a display module disposed in the opening and adhered to the open region, wherein the display module comprises a display layer and a back panel, wherein there is a gap disposed between a peripheral edge of the back panel and the inner edge, wherein the frame is not bolted to the back panel; and
a spacer disposed in the gap and extending an entirety of a distance between the peripheral edge and the inner edge.

2. The display system according to claim 1, wherein the gap surrounds an entirety of the peripheral edge of the back panel.

3. The display system according to claim 1, wherein the back panel comprises a backlight unit or a heatsink that is curved and comprises a surface with a minimum radius of curvature that is within 10% of that of the curved support surface.

4. The display system according to claim 1, wherein the spacer partially fills the gap.

5. The display system according to claim 1, wherein the spacer comprises at least one of polyurethane, a polyurea, a polyisocyanurate, a polyester, a polyphenol, a polyepoxide, nylon 6, a 1K component adhesive or sealant, and a 2K component adhesive or sealant.

6. The display system according to claim 1, wherein the spacer comprises a Young's modulus that is greater than 100 MPa.

7. The display system according to claim 1, wherein the spacer comprises a Young's modulus that is less than or equal to 50 MPa and is compressed inside the gap.

8. The display system according to claim 1, wherein the curved support surface comprises:
a length that is greater than or equal to 500 mm and less than or equal to 3000 mm;
a width that is less than half of the length; and
a minimum radius of curvature that is greater than or equal to 100 mm and less than or equal to 1500 mm.

9. The display system according to claim 1, further comprising at least one of:
a spacing element disposed between the curved support surface and the second major surface proximate to a periphery of the second major surface,
a step or through-hole on the curved support surface, and
a trough extending from the inner edge of the frame.

10. The display system according to claim 9, wherein:
the display system comprises the spacing element, and
the spacing element comprises a secondary adhesive bead comprising an unbonded surface that is not directly bonded to either the curved support surface or the second major surface.

11. The display system according to claim 1, wherein an outer surface of the adhesive layer is texturized.

12. A method of forming a display system, the method comprising:
cold-forming a glass substrate against a curved support surface of a frame with an adhesive layer disposed between the curved support surface and the glass substrate, wherein the frame comprises an opening;
laminating a display module to the glass substrate within the opening via a layer of optically clear adhesive, wherein the display module comprises a back panel and wherein a peripheral edge of the back panel is separated from an interior edge of the frame by a gap;
disposing a spacer in the gap, wherein the spacer bonds the back panel to the frame and maintains a shape of the gap; and
curing the adhesive layer such that the glass substrate is retained in a curved shape by the frame.

13. The method according to claim 12, wherein the cold-forming comprises:
applying a negative pressure to the glass substrate via a vacuum chuck to conform the glass substrate against the vacuum chuck; and
pressing the curved support surface against the glass substrate after the negative pressure is applied to the glass substrate.

14. The method according to claim 13, wherein:
the back panel is curved prior to being laminated to the glass substrate, and
the spacer bonds the back panel to the frame prior to the adhesive layer being cured.

15. The method according to claim 14, further comprising, prior to the adhesive layer being cured, removing the glass substrate, frame, and display module from the vacuum chuck, wherein the back panel retains the glass substrate in the curved shape prior to the adhesive being fully cured.

16. The method according to claim 12, wherein disposing the spacer comprises injecting spacer precursor material into the gap and curing the spacer precursor material.

17. The method according to claim 12, wherein disposing the spacer comprises attaching the spacer to the peripheral edge or the interior edge prior to laminating the display module to the glass substrate.

18. The method according to claim 12, wherein the cold-forming comprises dispensing adhesive of the adhesive layer on one of a curved support surface of the frame and glass substrate along a bead path, wherein the bead path comprises a shape that corresponds to a shape of a curved support surface of the frame.

19. The method according to claim 18, wherein dispensing the adhesive comprises controlling a dispensing rate of the adhesive as a function of a shape of the curved support surface.

20. The method according to claim 18, further comprising:
attaching a spacing element to one of the frame and the glass substrate prior to dispensing the adhesive, the spacing element configured to prevent the adhesive from flowing outward of the frame when the adhesive is compressed between the glass substrate and the frame; or
shaping the adhesive when the adhesive is compressed between the glass substrate and the frame via an adhesive shaping element disposed outward of the glass substrate.

21.-32. (canceled)
